(19) United States
(12) Patent Application Publication
(10) Pub. No.: US 2003/0035533 A1
(43) Pub. Date: Feb. 20, 2003

(54) System and method for automatic gain and slope equalization provisioning of telephone transmission lines

(76) Inventors: James Edward Sclater, Annandale, VA (US); William Vernon Miller III, South Riding, VA (US)

Correspondence Address: Roylance, Abrams, Berdo & Goodman, L.L.P., Suite 600, 1300 19th Street, Washington, DC, 20036, US

(21) Appl. No.: 09/928,440

(22) Filed: Aug. 14, 2001

(51) Int. Cl. H04M 1/00; H04M 3/00; H04M 7/00

(52) U.S. Cl. 379/347

(57) ABSTRACT

A system and method for automatic gain and slope equalization for provisioning telephone circuits is provided. A first unit is installed at the company end of a copper pair transmission line. A second unit is installed between customer premises equipment (CPE) and the copper pair transmission line. The second unit is programmed to disconnect the CPE, and to transmit a test signal, preferably comprising a square wave with a known amplitude and fundamental frequency of 1 kHz. The signal is received at the first unit, and the fundamental frequency and odd harmonic frequencies are analyzed. Based on the analysis, the first unit thereafter compensates for impairments in the transmission line. The test procedure can be initiated from either the first unit or the second unit. The first unit is programmed to produce a command sequence, preferably comprising a series of DC voltages applied to the tip and ring leads, and received at the second unit. The second unit is programmed to recognize the series of DC voltages and begin transmitting the test signal. The second unit is preferably able to signal the first unit to begin a test sequence by drawing a DC current through the tip and ring leads for a predetermined period of time, which is recognized by the first unit. The second unit is further adapted to be a passive device, and to have an energy storage device to provide power to the unit during transmission of the command sequence.

### FIELD OF THE INVENTION

The present invention is related to systems and methods for provisioning telephone circuits. More particularly, the present invention is related to a system and method for automatically compensating for gain and frequency response impairments in telephone transmission lines.

### BACKGROUND OF THE INVENTION

The process of adjusting gain and frequency response to compensate for impairments in a telephone transmission line is referred to as alignment. There are existing technologies which automate the alignment process to some extent; however, these generally require the use of specialized test equipment, and must be performed by a service technician from the customer site. One such channel unit “auto-alignment” technology offered requires that a service technician travel to the customer site, disconnect the customer equipment and connect a Transmission Impairment Measurement Set (TIMS), or equivalent test equipment, to the transmission line. The service technician must then complete a complicated nine-step process to properly align the channel-unit. In the event that the channel-unit should need to be replaced, or the alignment repeated for some other reason, the service technician must return to the customer site and repeat the entire process.

This nine-step alignment process employs an in-band signaling approach in which the TIMS is configured to send command tones at specific frequencies toward the channel unit from the customer site. These command tones instruct the unit as to which phase of the alignment process is to be performed. Command acknowledgment tones are sent back from the channel unit toward the service technician. A series of single-frequency tones at 404 Hz, 1004 Hz and 2804 Hz are sent toward the channel unit one at a time from the TIMS by the service technician during the alignment process. These three tones are evaluated on an individual basis in order to determine the gain and frequency response correction parameters.

### SUMMARY OF THE INVENTION

The above limitations are overcome, and other advantages are realized by providing a digital carrier based channel unit system that provides automatic gain and frequency response correction for twisted-pair transmission line impairments in both transmit and receive directions. In a preferred embodiment, the system consists of two devices, namely a metallic interface unit and a calibration unit. The metallic interface unit is a foreign-exchange station-end unit which is installed in a digital carrier channel bank at either an end-office or a remote-terminal location. The calibration unit is a “passive” line-powered device which is installed at the network interface of the customer premises location. The calibration unit is passive in that it is powered by the metallic interface unit, but does not interfere with the operation of the customer premises equipment, or the quality of transmission between the metallic interface unit and customer equipment under normal operating conditions.

The metallic interface unit and calibration unit system is a significant improvement over the current state of auto-alignment technology in that it truly automates that alignment process, does not require the use of special equipment, and may be performed at any time without making unnecessary trips to the customer site. The calibration unit is installed at the customer site at the same time that phone service is connected to the customer premises equipment. The auto-alignment sequence can be initiated from the customer site at the press of a button on the calibration unit with the metallic interface unit installed in the channel bank at the end-office or remote-terminal location. A unique signature current is used by the calibration unit to signal a request to the metallic interface unit to begin the auto-alignment sequence. The auto-alignment sequence may also be activated from the metallic interface unit simply by installing it in the channel-bank, or by setting its operating mode selection switch to the “AUTO ALIGN” position if already installed. Auto-alignment may be repeated at any time, without traveling to the customer location, by turning a switch or re-installing the metallic interface unit in the channel-bank.

Signaling from the metallic interface unit to the calibration unit is carried out using an advantageous out-of-band signaling method in which unique sequences of open and closed battery intervals are used to relay specific commands. The design of the calibration unit allows it to continue to operate even when its power source is removed during these signaling sequences. When directed by the metallic interface unit, the calibration unit disconnects the customer premises equipment tip and ring connections, and transmits a composite multi-tone test signal towards the metallic interface unit. The composite test signal is a square wave of known amplitude, consisting of a 1 kHz fundamental Fourier component and its odd harmonics. The relative amplitude of each harmonic is related through Fourier analysis to that of the fundamental by a factor of (1/n), where n is the order of the harmonic. The metallic interface unit filters the received composite test signal, analyzes the 1 kHz fundamental and 3 kHz harmonic components via a Discrete Fourier Transform based algorithm, and automatically adjusts the overall gain and frequency response characteristics of its two-wire side transceiver to compensate for impairments in the twisted-pair transmission line in both transmit and receive directions. Following the determination of a gain and slope solution, the metallic interface unit sends a second instruction to the calibration unit, commanding it to again disconnect the customer premises equipment tip and ring connections and apply a 900-ohm +2.15 uF quiet-termination. The metallic interface unit then measures C-Message weighted idle-channel noise on the twisted pair circuit. Should the result of the measurement indicate that the noise level exceeds a nominal threshold of 32 dBrnC0, the metallic interface unit notifies the service technician by flashing an LED on the front-panel of the metallic interface unit. This noise measurement feature further automates the circuit setup process in that the service technician need not travel to the customer site to perform the line-qualification with specialized test equipment.

The metallic interface unit also employs an adaptive echo-cancellation technology to compensate for impedance mismatch presented to its two-wire side by the customer equipment load, as transformed through the transmission line. The combination of automatic gain and frequency response correction technology with adaptive echo-cancellation simplifies circuit provisioning by eliminating the manual adjustment of option switches that set gain, slope equalization, and both compromise and precision balance networks. In some instances, up to forty-two manual adjustments may be eliminated. By reducing the number of options that must be set manually, the possibility for human error is also reduced, thereby increasing the accuracy in provisioning a circuit. In addition, the need for qualifying individual loop-plants in order to determine appropriate manual option settings prior to turn-up is eliminated, as the qualification is performed automatically by the metallic interface unit and calibration unit. The metallic interface unit and calibration unit benefits telephone companies, as well as the end consumer, by reducing both the time and labor costs associated with turning-up a telephone circuit, providing for consistent voice-channel quality, and optimizing performance on an individual loop-plant basis.

### BRIEF DESCRIPTION OF THE DRAWINGS

Other objects and features of the present invention will become apparent from the following detailed description considered in connection with the accompanying drawings that disclose a preferred embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a block diagram of an embodiment of the present invention;

FIG. 2 is an illustration of the calibration unit installed in an office building setting;

FIG. 3 is an illustration of the calibration unit installed in a typical residential home;

FIG. 4 is an illustration of the metallic interface unit and calibration unit installed in various types of telephone circuits;

FIG. 5 is a simplified block diagram of an embodiment of the calibration unit;

FIG. 6 is a circuit diagram of an embodiment of the calibration unit;

FIG. 7 is a state diagram illustrating the functionality of the calibration unit microcontroller;

FIG. 8 is a block diagram of an embodiment of the metallic interface unit;

FIG. 9 is a state diagram illustrating the functionality of the metallic interface unit microcontroller auto-alignment feature; and

FIGS. 10a and 10b illustrate out of band command sequences exchanged between the metallic interface unit and the calibration unit.

### DETAILED DESCRIPTION OF THE INVENTION

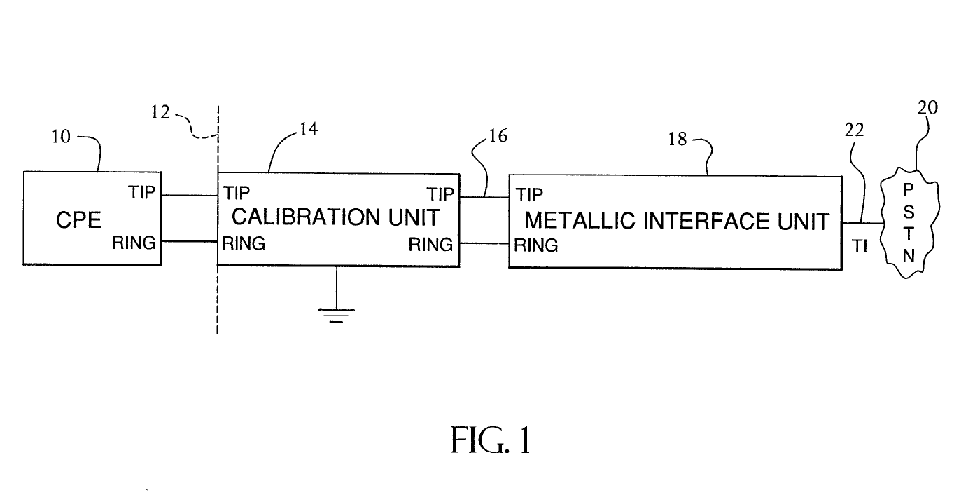

Referring to the drawings, FIG. 1 is a block diagram of a system according a preferred embodiment of the present invention. Customer Premises Equipment (CPE) 10 is typically connected to the telephone company at a network interface 12 at the customer's location. According to an embodiment of the present invention, the CPE 10 is connected to a calibration unit 14 at the network interface 12. The calibration unit 14 is in turn connected to the copper pair 16 leading to a channel unit. Channel units are well known in the art of telephone networks, and perform the function of converting analog signals from a telephone line on the copper pair 16 into digital signals which can be transmitted to and from the telephone network 20 over a digital carrier, such as a T1 line 22. However, according to a preferred embodiment of the present invention, the channel unit is a metallic interface unit 18 which is specially designed to interact with the calibration unit 14 installed at the customer location, in addition to performing the usual functions of a channel unit.

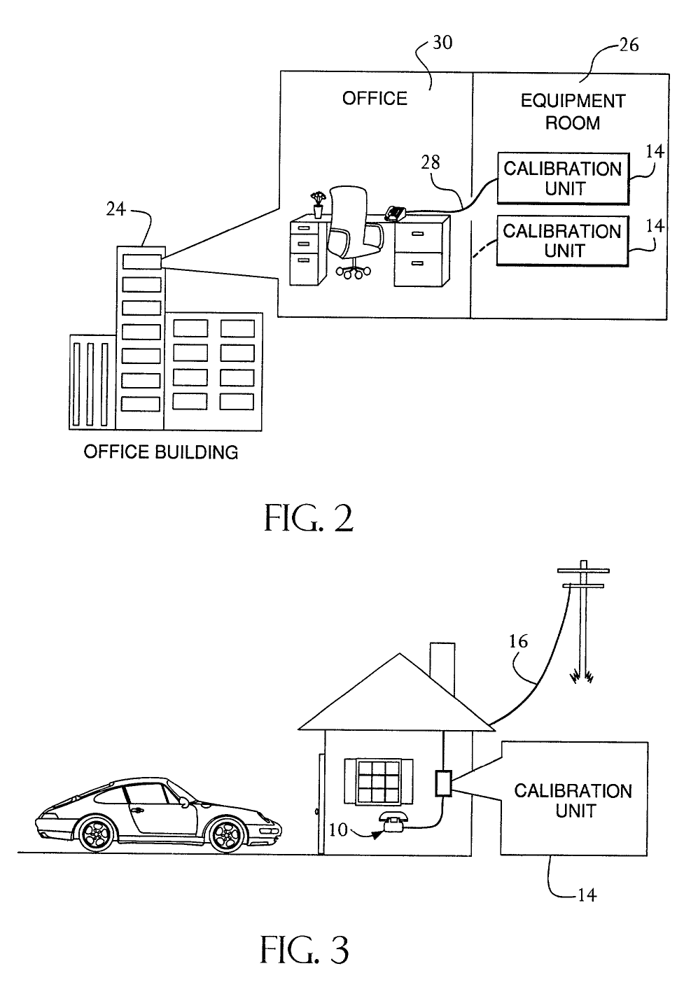

FIG. 2 shows a typical application of the calibration unit in an office building 24. An equipment room 26 preferably may contain a plurality of calibration units 14, each connected to an individual phone extension 28 within the office 30. The calibration units 14 are each connected to a corresponding metallic interface unit device (not shown), which could be arranged conveniently in, for example, a bank of metallic interface channel units at a central location.

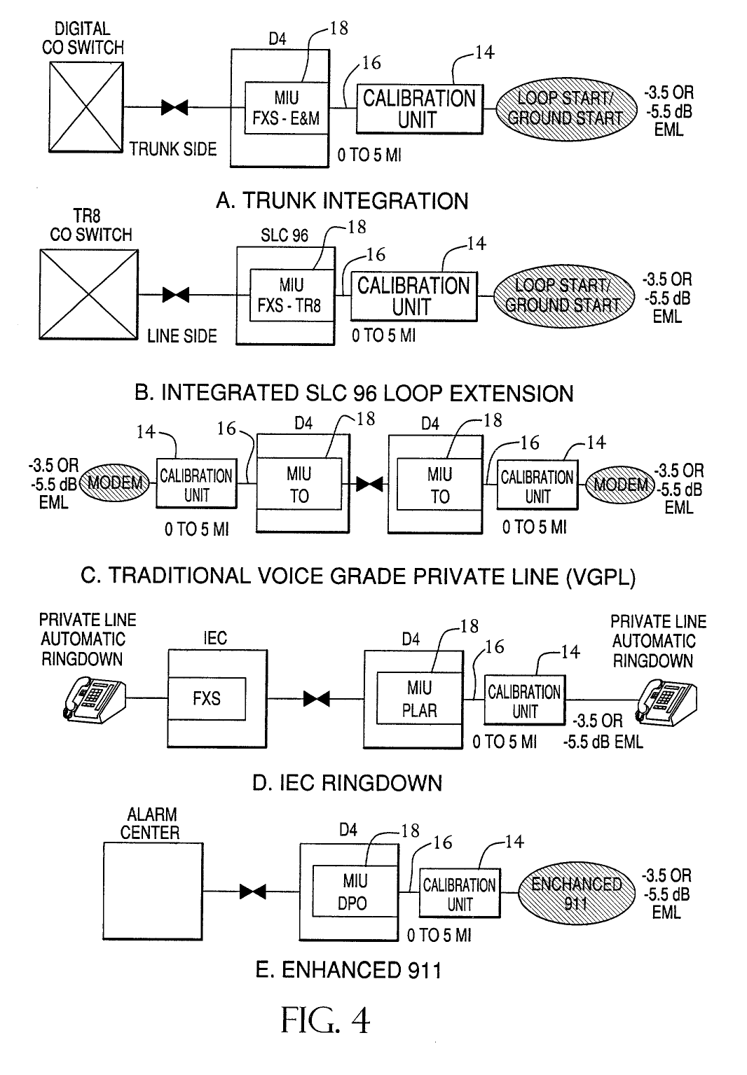

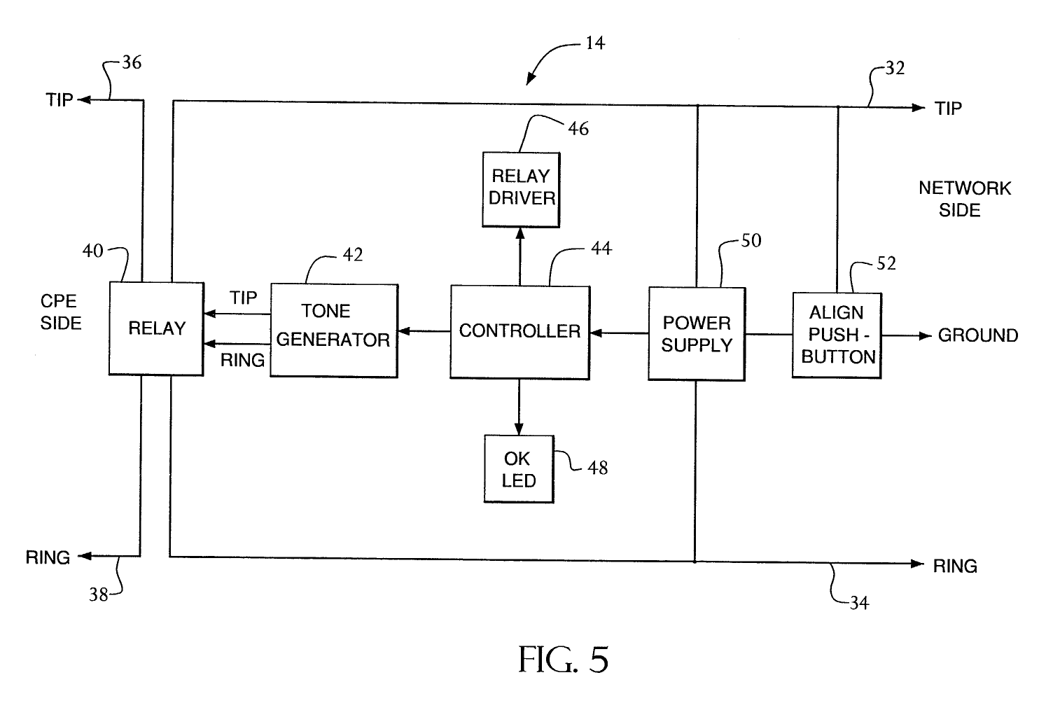

FIG. 3 shows a typical residential application of a system according to the present invention. The calibration unit 14 is installed between the copper pair 16 entering the home, and the CPE 10 installed within the home. Of course, those of ordinary skill in the art will readily recognize that many other arrangements of the calibration unit 14 and metallic interface unit 18 pair are possible within various telephone network configurations, as shown in FIG. 4. In general, the calibration unit 14 and metallic interface unit 18 are located at opposite ends of an individual copper pair, with the calibration unit 14 located at the customer end of the copper pair.

In practice, the calibration unit 14 temporarily disconnects the CPE 10 from the copper pair 16, and transmits a test tone over the copper pair 16 which is received by the metallic interface unit 18. The metallic interface unit 18 analyzes the received test tone and determines the transmit and receive attenuation, and slope equalization required to deliver a −3.5 dBm level at 1 kHz into a 900 ohm +2.15 uF termination at the network interface 12 of the CPE 10. The metallic interface unit thereafter compensates for frequency dependent impairments in the line by applying the determined gain and slope equalization to the line. The process of measuring line impairments and compensating for the impairments is known as auto-alignment. Conveniently, the auto-alignment sequence can be initiated from either the metallic interface unit 18 or the calibration unit 14. Once the auto-alignment sequence has been completed, the calibration unit re-connects the CPE 10 to the copper pair 16.

### Calibration Unit

FIG. 5 is a block diagram of the calibration unit 14. Tip 32 and ring 34 connections are provided at the telephone network side of the calibration unit 14. Tip 36 and ring 38 connections are also provided at the CPE 10 side of the calibration unit 14. The calibration unit 14 is provided with a relay 40 for connecting or disconnecting the CPE 10 from a telephone network. The calibration unit is also provided with a tone generator 42 for transmitting tones over the copper pair back toward the metallic interface unit 18. A controller 44 is provided for controlling the operation of the calibration unit's 14 various functions. The calibration unit includes a relay driver 46 as well an indicator LED 48. There is also a power supply 50 and a push button control 52 provided.

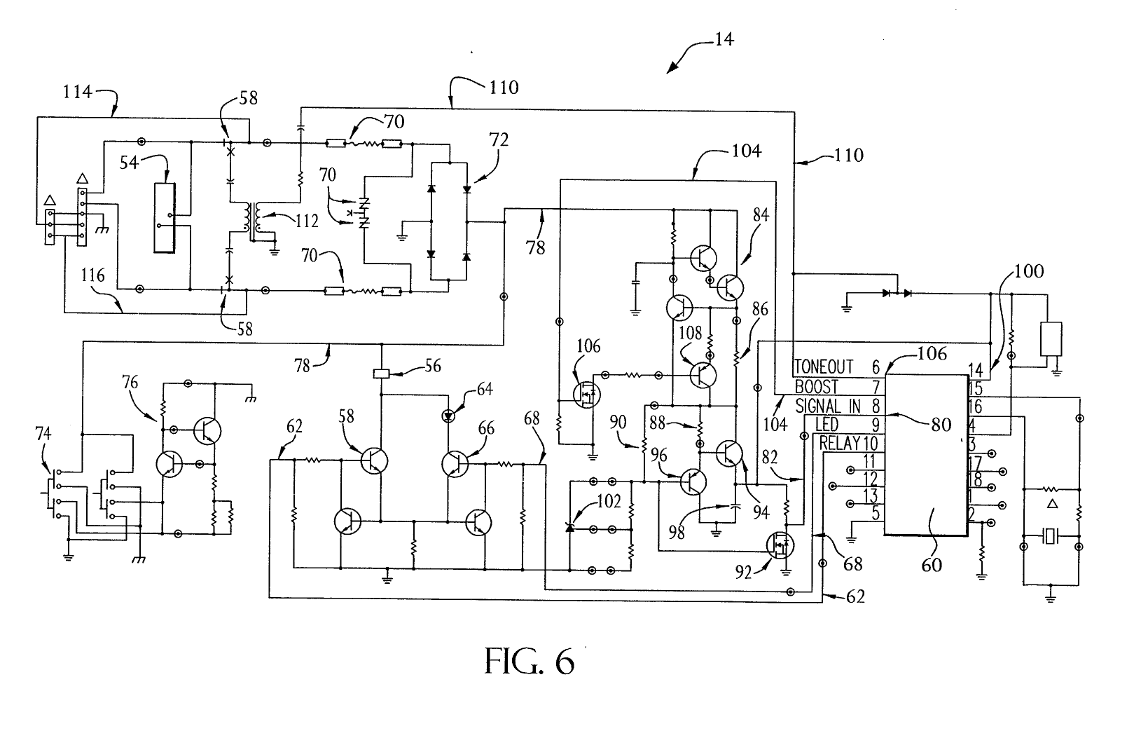

FIG. 6 is a detailed circuit diagram of a preferred embodiment of the calibration unit 14. The calibration unit is provided with a network interface connector 54 for connecting CPE 10 (not shown) to the calibration unit 14. A relay coil 56 is provided for controlling relay contacts 58 for connecting or disconnecting the CPE 10. Relay coil 56 is energized by transistor 58, which is turned on or off by the microcontroller 60 via relay control line 62. An indicator LED 64 is also controlled by the microcontroller 60 by turning on or off transistor 66 via control line 68. The current path when the transistor 66 is turned on is through the relay coil 56 through the LED 64 and through the control transistor 66 so that the relay 56 is always energized when the LED 64 is being illuminated. Relay coil 56 may then be energized with the LED 64 turned off via control line 62, or with the LED 64 turned on via control line 68.

The preferred embodiment of the calibration unit 14 further comprises surge protecting means 70 for protecting the calibration unit 14 circuitry from surges occurring on the tip or ring leads. The calibration unit 14 also has DC rectifying means, shown generally at 72. The calibration unit 14 is provided with a push button switch 74, which once pushed, activates a current source circuit 76, which in turn sinks current from the tip lead 114 and/or frame ground (FGND) lead via the rectifier bridge 72 toward the ring lead 116. The tip 114 and ring 116 leads are connected to the telephone network, and in particular to the tip and ring leads of the metallic interface unit (not shown). The frame ground lead (FGND) is connected to earth-ground, which is the reference ground for the telephone network, as is the frame ground (FGND) lead of the metallic interface unit (not shown). In this manner an out of band signaling means is provided between the calibration unit 14 and the metallic interface unit. The metallic interface unit is provided with logic to recognize the current sinking condition caused when push button 74 is depressed. Thus, if push button 74 is depressed for a predetermined length of time, between five and ten seconds for instance, the metallic interface unit recognizes this as a command to begin the auto-alignment process initiated from the calibration unit.

The auto-alignment sequence can also be initiated from the metallic interface unit by transmitting a special out-of-band signaling sequence over the tip and ring leads from the metallic interface unit to the calibration unit 14, which is received at the microcontroller 60 through input port 80 on “Signal In” line 82.

The out-of-band signaling sequence from the metallic interface unit to the calibration unit will now be described in further detail. When the metallic interface unit needs to remotely signal the calibration unit to begin the auto-alignment sequence, the metallic interface unit applies a predetermined series of alternating voltage changes to the tip and ring leads. These voltages are alternating open and closed battery intervals applied at a frequency which is below audible frequencies, such as, for instance 5 (five) Hz, and at a specific duty cycle such as 24%. A command which instructs the calibration unit to begin the auto-alignment sequence may comprise for instance 13 alternations between a high and low voltage followed by, for example a one half-second pause followed by another 13 alternations between high and low voltages. When a closed battery interval is received at the calibration unit tip 114 and ring 116 leads, the output 78 of rectifier 72 turns on a current source shown generally at 84 in turn driving current through resistors 86, 88 and 90, and turning on FET 92 thereby driving the voltage at “Signal-In” line 82 and hence input port 80 to logic-zero level for the duration of the signal interval. Transistors 94 and 96 are also turned on during receipt of a high voltage signal from the metallic interface unit, causing power supply capacitor 98 to fully charge. Power supply capacitor 98 stores energy which is used to supply power to the microcontroller 60 through power supply port 100. Zener diode 102 ensures that the power supply capacitor 98 is charged to the appropriate voltage to supply power to the microcontroller 60 through power-supply port 100.

Once the microcontroller 60 recognizes the appropriate signaling sequence at input port 80, a boost circuit is turned on through boost line 104. The boost signal over boost line 104 turns on FET 106 which in turn activities transistor 108, increasing the current delivered to power-supply capacitor 98 and power-supply port 100 of the microcontroller 60.

The microcontroller 60 is programmed such that when the controller receives the appropriate signaling sequence through input port 80 commanding the calibration unit 14 to begin the auto-alignment procedure, the controller produces a test tone signal at port 106 which is transmitted over the tip and ring leads toward the metallic interface unit (not shown). The controller is programmed to produce a 1 kHz square-wave signal. The 1 kHz square-wave signal is applied to output signal line 110, coupled through transformer 112 and relay contacts 58 and finally onto tip 114 and ring 116 leads which are connected to the metallic interface unit through the copper pair (not shown).

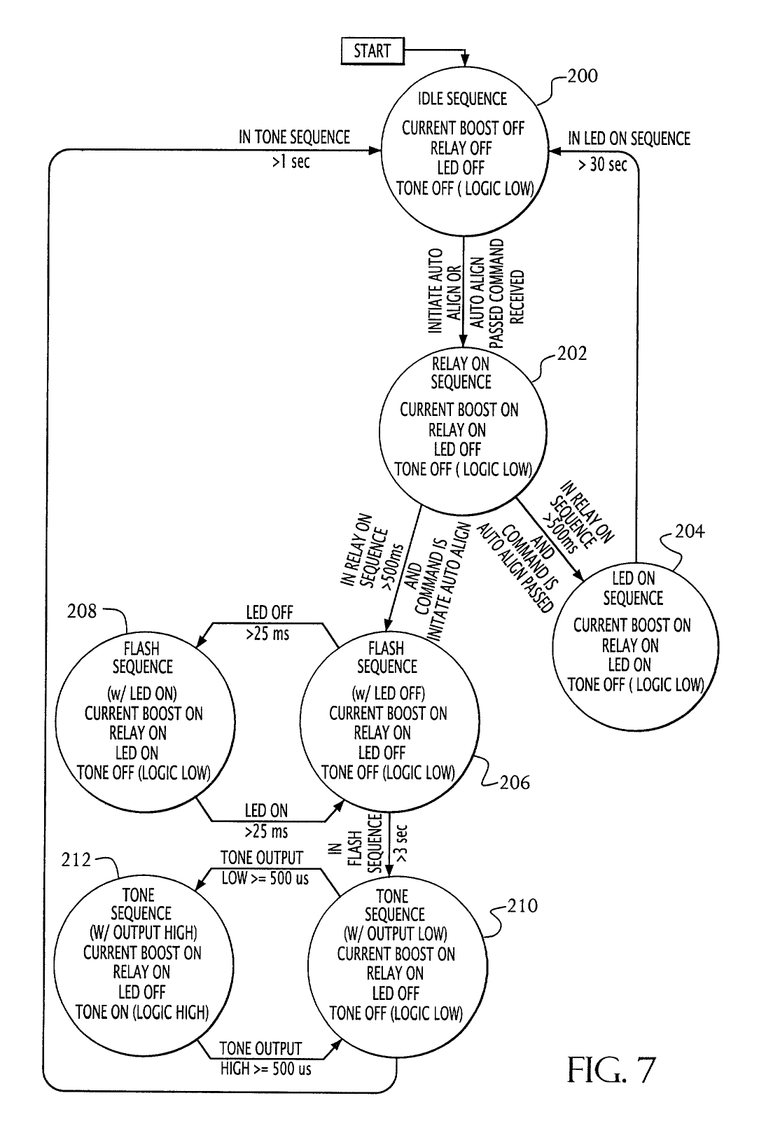

Turning to FIG. 7, the functionality of the microcontroller 60 of the calibration unit will now be described. The calibration unit starts in an “idle sequence” 200. While in the idle sequence, the current boost line 104 remains low, so that the current boost circuit remains off. Also, the relay 56 and the LED 64 are not energized, and the tone output 110 remains low. If the Auto-Align sequence is initiated, either from push-button 74 or from receiving the Auto-Align Initiate command from the metallic interface unit through the out-of-band signaling described above, or if the Auto-Align Passed command is received, the calibration unit microcontroller 60 enters a “relay on sequence” 202. While in the relay on sequence, the boost circuit is turned on through boost line 104. This draws the current necessary to run the calibration unit during the following processes. Also, the relay 56 is energized, but LED 64 remains off. Also, during this sequence, the tone-out 110 remains low.

Once the microcontroller 60 has been in the “relay on sequence” 202 for more than 500 ms, it moves to either the “LED on sequence” 204 or the “flash sequence,” 206, 208 depending on which command was received. If the “Auto-Align Passed” command was received, the microcontroller 60 enters the “LED on sequence” 204. In this sequence the boost circuit remains on, the relay 56 remains energized, and the LED 64 is turned on. Also, the tone out line 110 remains low. After 30 seconds in the LED on sequence 206, the calibration unit microcontroller returns to the idle sequence 200.

If the “Initiate Auto Align” commands was received, the microcontroller moves from the “relay on” sequence 202 to the “flash sequence” 206, 208. During the “flash sequence,” the microcontroller flashes the LED 64 on and off for 25 ms intervals. The relay 56 remains energized throughout the “flash sequence”; control port 62 is activated when control port 68 is deactivated, and vice-versa so that the relay 56 remains energized while the LED 64 is switched on and off. The current boost 104 remains high throughout the flash sequence and the tone out line 110 remains low.

After the microcontroller 60 has been in the flash sequence for 3 seconds, the “tone sequence” 210, 212 begins. During the tone sequence 210, 212, the boost line 104 remains high, providing current to run the calibration unit. Also, the relay 56 remains energized and the LED 64 remains off. The tone out line 110 alternates between high and low for 500 us intervals, generating a 1 kHz square wave signal, which lasts at least one second. Once the tone sequence 210, 212 is complete, the calibration unit microcontroller returns to the idle sequence 200.

### Metallic Interface Unit

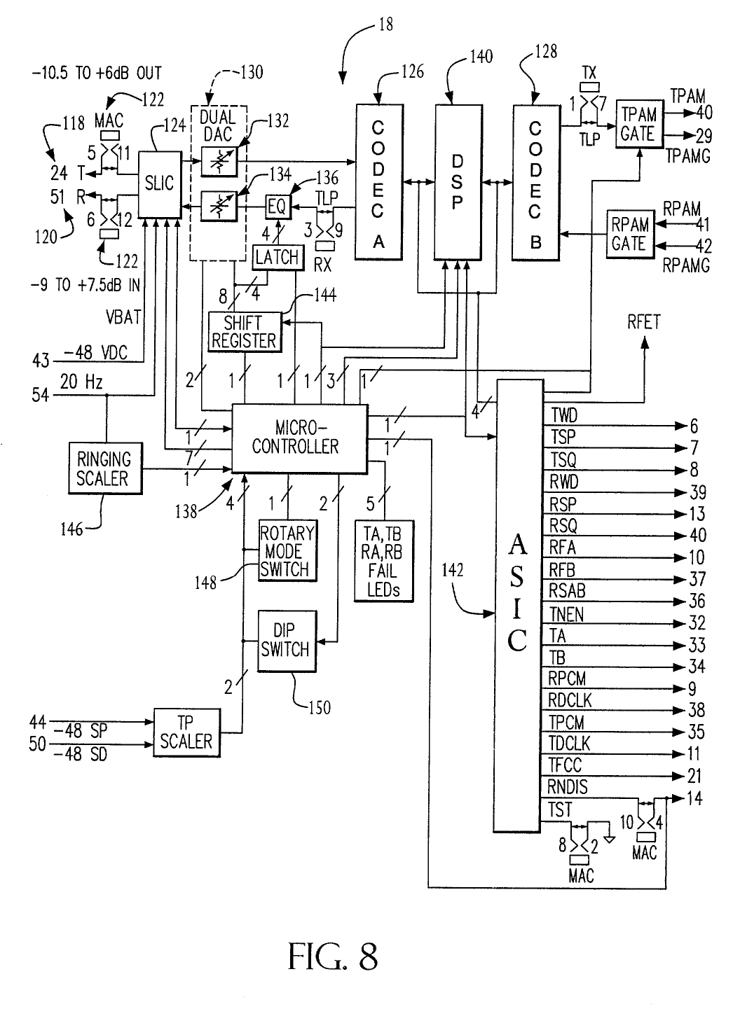

FIG. 8 illustrates a block diagram of the metallic interface unit 18. The metallic interface unit 18 is provided with tip 118 and ring 120 ports connected to the copper pair leading from the calibration unit (not shown). Maintenance Access Connector (MAC) ports 122 are provided. A SLIC 124 provides an interface between the subscriber side tip 118 and ring 120 leads and the encoder/decoder (CODEC) 126, 128 circuits by way of the dual digital-to-analog converter (DAC) 130. The dual DAC 130 is provided with Tx and Rx attenuators 132, 134. The metallic interface unit 18 is also provided with a Rx line equalizer 136. The SLIC and external circuitry synthesize two-wire impedance set to 900 ohm and 2.15 uF. The SLIC 124 provides internal loop and ground key detectors which are monitored by the micro controller 138. The SLIC 124 also provides battery reversal and typical conditions for line side answer supervision and ground start applications, and controls the application of ringing. The SLIC 124 is also used in conjunction with a shorting circuit across tip 118 and ring 120 to send coded out-of-band command sequences (described above), consisting of open battery intervals, to the calibration unit (not shown) in order to command the calibration unit to begin the auto-alignment sequence.

The dual DAC 130 sets attenuation in both transmit and received directions. Each 8 bit DAC 132, 134 is configured by the microcontroller 138 to provide between 0 and 16.5 dB of attenuation. The transmit and receive DAC settings are determined by a digital signal processor (DSP) 140 during the auto-alignment sequence.

In the preferred embodiment, the DSP 140 and the microcontroller 138 communicate with one another via a 16-bit control word and a 16-bit response. The control word includes FM bits that instruct the DSP to perform various functions. The response word includes PQ bits that can indicate the results of a function performed by the DSP. Of course other means of communication between the DSP 140 and the microcontroller 138 could be devised without departing from the spirit of the invention.

The equalizer 136 provides slope equalization in the receive direction, and is configured by the microcontroller 138. The slope setting is determined by the DSP 140 during the auto-alignment sequence. Slope equalization in the transmit direction is accomplished within the DSP 140.

A first CODEC 126 provides the analog to digital and digital to analog interface between the analog voice band signals at tip 118 and ring 120, and the DSP 140. The first CODEC 126 receives frame sync timing and 1.544 MHz master clock from the back plane via an ASIC 142 when the channel unit is operating in PCM mode and 2.560 MHz when in PAM mode.

Digital data exchange between the first CODEC 126 and the DSP 140 represents linearly encoded voice band signals. The ASIC 142 controls PAM and PCM modes of operation according to automatic detection of digital back planes.

ASIC 142 and CODECs 126, 128 provide an analog-to-digital and digital-to-analog interface between the back plane PAM bus and the DSP 140. The second CODEC 128 receives frame sync timing and 1.544 MHz master clock from the back plane via the ASIC 142 when the channel unit is operating in PCM mode and 2.560 MHz when in PAM mode, and provides the transmit TLP interface (Tx TLP).

Digital data exchange between the second CODEC 128 and DSP 140 represents linearly encoded voice band signals. The ASIC 142 controls PAM and PCM modes of operation according to automatic detection of the digital back plane.

During the auto-alignment sequence, the DSP 140 analyzes the test tone received from the calibration unit 14 and determines the proper slope and attenuation setting in the transmit and receive paths to compensate for loss and roll-off introduced by the twisted pair located between the CPE 10 and the metallic interface unit tip 118 and ring 120 ports. As described above, the test tone received from the calibration unit 14 consists of a square wave with a fundamental frequency component of 1 kHz at −8.1 dBm into 900 ohm. The third harmonic at 3 kHz is approximately 9.5 dB below the fundamental as generated by the calibration unit. The DSP 140 determines a slope setting by taking a Discrete Fourier Transform (DFT) of the square wave received from the calibration unit and comparing the relative amplitudes of the 1 kHz and 3 kHz components. The DSP 140 calculates 5 values: the prescription type 309D slope equalization setting, as well as two user selectable attenuation setting configurations for both the transmit and receive directions; for instance, the user may select either a 3.5 dB EML (Expected Measured Loss) transmit and 0 dB EML receive path loss, or a 5.5 dB EML transmit and 0 dB EML receive path loss. The microcontroller 138 determines which set of attenuation settings to use based on the position of EML option switch 150.

The microcontroller 138 is connected to the SLIC 124, the dual DAC 130, the DSP 140 and ASIC 142. The microcontroller 138 is also connected to a shift register 144 and a ringing scalar 146. The mode of operation of the metallic interface unit 18 can be altered through rotary mode switch 148 and dip switches 150 which are connected to the microcontroller 138. The auto-alignment sequence may be started by turning rotary mode switch 148 to the “auto-align” position. The metallic interface unit microcontroller 138 is also programmed to initiate the auto-alignment sequence whenever the metallic interface unit is plugged into a channel bank (not shown). Auto-alignment may be repeated at any time, without traveling to the customer location by turning the rotary mode switch 148 to the “auto-align” position or by reinstalling the metallic interface unit 18 into the channel bank. The microcontroller 138 is further provided with logic to recognize an out-of-band signature current drawn by the calibration unit 14 when push button 74 is depressed for the appropriate length of time. Thus, the auto-alignment sequence can be initiated from either the calibration unit side or the metallic interface unit side of the copper pair 16.

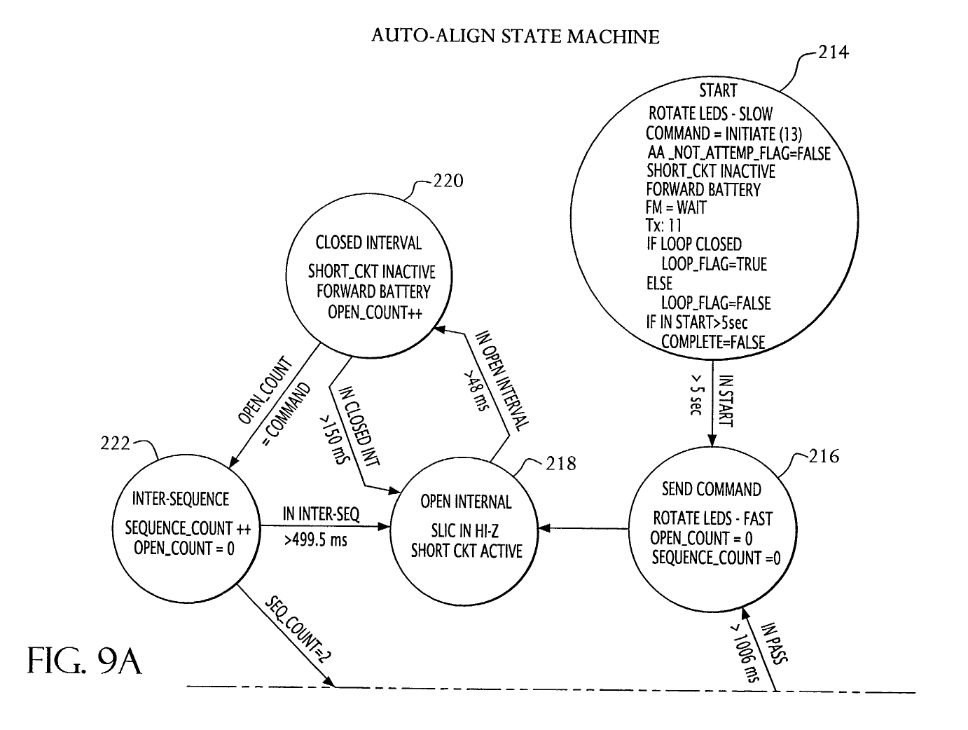

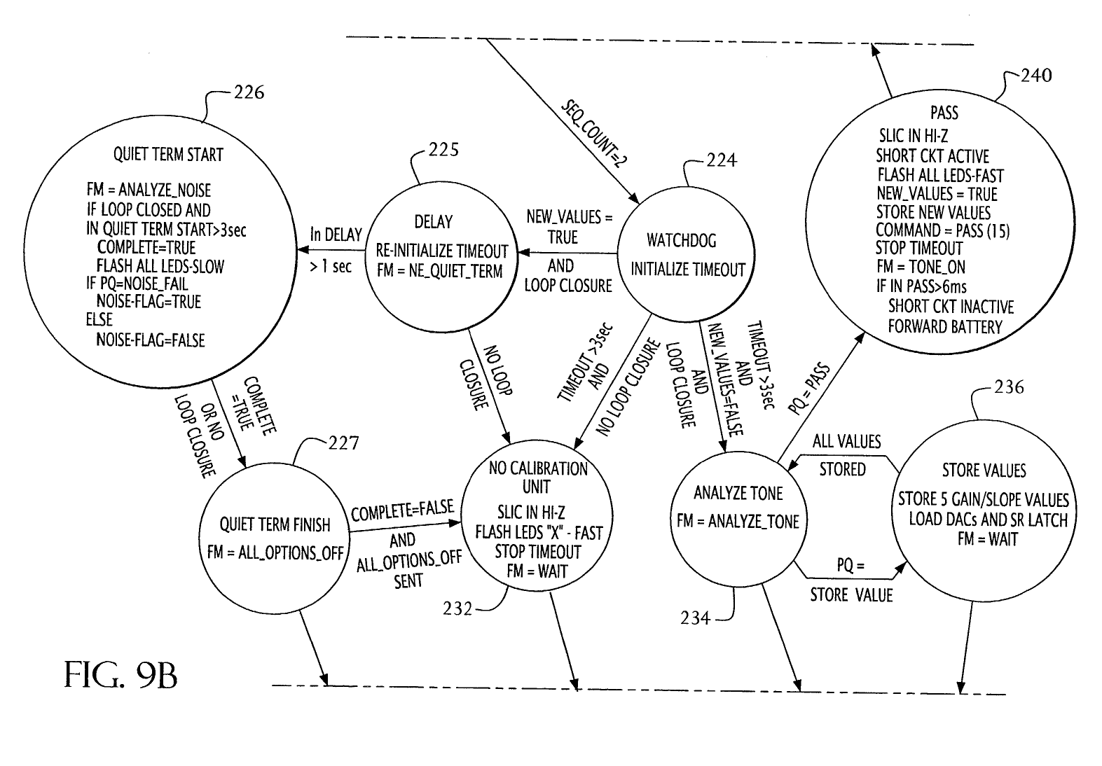

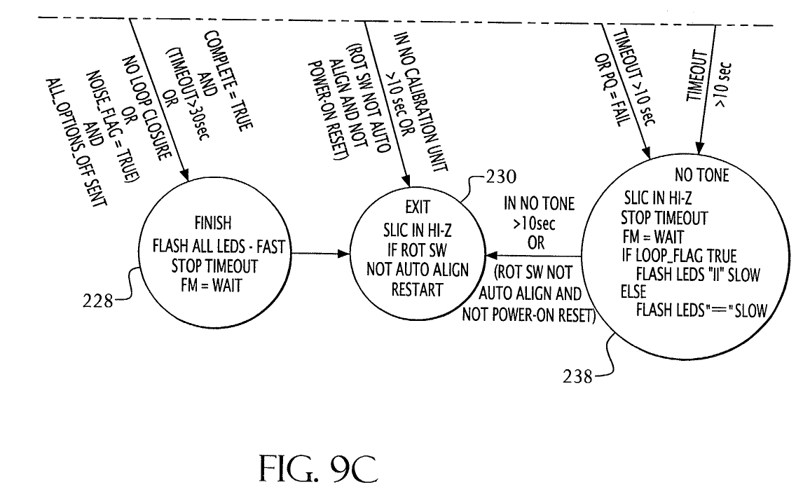

Turning to FIG. 9, the auto-alignment functionality of the microcontroller 138 of the metallic interface unit 18 will now be described. The metallic interface unit begins in the “start” mode 214. During “start”, the microcontroller 138 applies battery to the tip and ring and allows time for the energy storage capacitor 98 in the calibration unit 14 to fully charge. The variable “COMPLETE”, which indicates the status of the combined gain and slope alignment and idle-channel noise test, is initialized to the value FALSE. The variable “COMMAND” is set to INITIATE, indicating that the instruction to be sent to the calibration unit 14 will cause it to generate the auto-alignment test signal. Also if the metallic interface unit detects that a closed loop condition exists at the near-end, the variable “LOOP_FLAG” is set to TRUE, otherwise, it is set to FALSE.

After the metallic interface unit has been in start mode 214 for 5 seconds, it moves to the “send command” state 216. Here, the variables SEQUENCE_COUNT and OPEN_COUNT are initialized by setting both to zero. OPEN_COUNT indicates the number of open-battery intervals that are to be generated during the signaling intervals 218, 220, thereby forming the command to be sent to the calibration unit 14. SEQUENCE_COUNT indicates the number of times that the command represented by OPEN_COUNT has been sent. Next, the microcontroller 138 begins transmitting a command sequence to the calibration unit via the tip 118 and ring 120 leads.

The command sequence is illustrated at 218, 220 and 222. It begins with an open battery interval 218, which lasts for 48 ms. Next, there is a closed battery interval 220 for 150 ms, during which OPEN_COUNT is incremented by one. The open interval 218 and closed interval 220 alternate until OPEN_COUNT is equal to COMMAND, which is either 13 for the INITIATE command, or 15 for the PASS command. The INITIATE command is sent to instruct the calibration unit 14 to generate the auto-alignment test signal for gain and slope determination. The PASS command is sent to instruct the calibration unit 14 to apply a quiet-termination at the CPE for idle-channel noise testing, and to illuminate its LED 64 for 30 seconds. For illustrative purposes, only the “Initiate Auto Align” command (COMMAND=13) will be described. After 13 sets of open and closed intervals 218, 220, the microcontroller enters an inter-sequence step 222, which lasts for 499.5 ms. During the inter-sequence step, SEQUENCE_COUNT is incremented and OPEN_COUNT is reset to zero. Next, the open interval 218 and closed interval 220 are repeated 13 more times. When the microcontroller enters the inter-sequence step 222 the second time, SEQUENCE_COUNT is incremented to equal two, causing the microcontroller 138 to enter the “watchdog” state 224.

Thus, the command sequence (for the “Initiate Auto Align” command) comprises thirteen sets of open and closed intervals, followed by a half second inter-sequence interval, followed by thirteen sets of open and closed intervals. The frequency of the command sequence realized on the tip 118 and ring 120 leads is well below audible frequencies due to the duration of each interval. Furthermore, because the number of open-closed sequences is repeated twice with a pause in between, it is highly unlikely that such an event would ever occur by accident. Thus, when the calibration unit detects the command sequence, there is a high degree of confidence that the command was intended.

When the watchdog state 224 is entered, a TIMEOUT timer is initialized to zero and begins tracking the elapsed time. If NEW_VALUES equals TRUE (indicating that a gain and slope alignment solution has been determined), the microcontroller enters the “delay” state 225 where TIMEOUT is reinitialized to 30 seconds and the DSP is instructed to break the voice path in the receive direction and send quiet-termination towards the calibration unit 14. After 1 second, the microcontroller enters the “quiet term start” mode 226, and remains there until COMPLETE equals TRUE (indicating that the idle-channel noise test has been run for at least 3 seconds), or “no loop closure” is detected.

During the “quiet term start” mode 226, the metallic interface unit microcontroller 138 instructs the DSP 140 to measure idle-channel noise. If the loop remains closed for three seconds, the metallic interface unit microcontroller 138 flashes its signaling LEDs (not shown) slowly and sets COMPLETE equal to TRUE to indicate that the auto-alignment process has completed (both a gain and slope solution has been determined and the idle-channel noise test has been completed). The metallic interface unit microcontroller 138 then checks the DSP 140 response PQ for the results of the idle-channel noise test. If the DSP 140 indicates that the noise level exceeded 32 dBmC0 (decibels above reference noise, where the reference noise power is defined as 1 picowatt, with C-Message weighting, at the zero transmission level point), the variable NOISE_FLAG is set to TRUE; otherwise NOISE_FLAG is set to FALSE, causing the FAIL LED on the front panel of the metallic interface unit to flash in order to indicate that the idle channel circuit noise exceeds 32 dBrnC0. If COMPLETE is TRUE, or “no loop closure” is detected, “quiet term finish” mode 227 is entered.

Within “quiet term finish” 227, the microcontroller instructs the DSP 140 to turn off all options, thereby discontinuing idle-channel noise analysis and restoring the voice-path in both transmit and receive directions. If COMPLETE is FALSE, the “no calibration unit” state 232 is entered; otherwise, if COMPLETE is TRUE and either “no loop closure” is detected or NOISE_FLAG is true or TIMEOUT has reached 30 seconds, the “finish” state 228 is entered. Also, “no calibration unit” 232 can be entered directly from “watchdog” 224 if TIMEOUT reaches 3 seconds, and “no loop closure” is detected, or from “delay” 225 if no loop closure is detected.

In finish mode 228, the microcontroller causes the LED's to flash rapidly, stops the TIMEOUT timer, and instructs the DSP to standby by setting FM to “WAIT.” Next the microcontroller moves to “Exit” 230. Once in “exit” 230, if the rotary switch 148 is not set to “Auto-Align” the metallic interface unit is restarted.

From the “watchdog” state 224, if the TIMEOUT timer exceeds three seconds and “no loop closure” is detected, then the calibration unit has not been detected, and the “no calibration unit” state 232 is entered. In the “no calibration unit” state 232 the LED's are flashed in an “X” pattern rapidly, and the TIMEOUT timer is stopped. If the microcontroller is in the “no calibration unit” state 232 for more than 10 seconds, or if the rotary switch 148 is not set to “Auto Align” and the auto-alignment sequence was not entered as the result of “Power-On Reset”, the exit state 230 is entered.

From the “watchdog” state 224, if TIMEOUT reaches 3 seconds and NEW_VALUES is FALSE (indicating that the DSP 140 has not yet attempted to determine a gain and slope solution) and “loop closure” is detected, then the “Analyze Tone” state 234 is entered. Entering the “Analyze Tone” state 234 indicates that the calibration unit is present, and that the alignment test signal should be detected. FM is set to “Analyze Tone” to instruct the DSP 140 to analyze the test signal received from the calibration unit 14. When the DSP response PQ is set to “Store Value”, the “Store Values” state 236 is entered. On the other hand, if TIMEOUT reaches 10 seconds, or if the DSP 140 returns PQ set to “FAIL”, the “No Tone” state 238 is entered.

In the “Store Values” state 236, the microcontroller stores five values of gain and slope. FM is set to “Wait.” If TIMEOUT reaches 10 seconds while the microcontroller is in “Store Values” 236, it moves to the “No Tone” state 238. In the “No Tone” state 238, the TIMEOUT timer is stopped, and FM is set to “Wait” in order to instruct the DSP 140 to standby. Also, if the LOOP_FLAG variable is set to TRUE, the four signaling LED's (TA, TB, RA, and RB) are flashed in a vertical pattern (“∥”) to indicate that an off-hook condition existed prior to the attempted auto-alignment and is the most probable cause for not receiving an alignment test signal from the Auto FX 14; otherwise, the LED's are flashed in a horizontal pattern (“=”) to indicate that the test signal from the Auto FX 14 was detected, but the level of the received signal was below the −25 dBm threshold required for accurate gain and slope alignment. If the microcontroller is in “No Tone” 238 for more than 10 seconds, or if rotary switch 148 is not set to “AutoAlign” and the auto-alignment sequence was not entered as the result of “Power-On Reset”, then “Exit” 230 is entered.

From the “Store Values” state 236, if all five of the most recent iterative gain and slope values are downloaded from the DSP 140 and loaded into the DAC attenuators 132 and 134 and slope equalizer latch 136 successfully, then the microcontroller 138 returns to the Analyze Tone 234 state. If the PQ response from the DSP 140 indicates that an acceptable gain and slope solution was determined (PQ equal to PASS), then “Analyze Tone” 234 is exited and the “pass” state 240 is entered. In the “pass” state 240, the SLIC 124 is put into a high impedance state and a shorting circuit (not shown) at the metallic interface unit 18 tip 118 and ring 120 leads is activated to ensure that the calibration unit 14 is powered down and reset. Also, the signaling LED's are flashed rapidly, a NEW_VALUES variable is set to “TRUE” (indicates that a gain and slope solution has been determined), and COMMAND is set to “PASS.” Finally, the TIMEOUT timer is stopped and FM is set to “TONE ON” in order to instruct the DSP 140 to generate a 0 dBm 1 kHz signal in both transmit and receive directions. The 0 dBm 1 kHz signal, or digital milliwatt, is used as an audible indication of the successful determination of a gain and slope solution.

Once the microcontroller has been in “pass” 240 for 6 ms, the shorting circuit is deactivated and forward battery is restored in order to power up the Auto FX 18 in preparation for receiving the next command. After 1006 milli-seconds in the “pass” state 240 the microcontroller 138 returns to “Send Command” 216. Because COMMAND is now set to “PASS”, the command sequence is set to comprise 15 open-closed intervals followed by an inter-sequence interval and another 15 open-closed intervals.

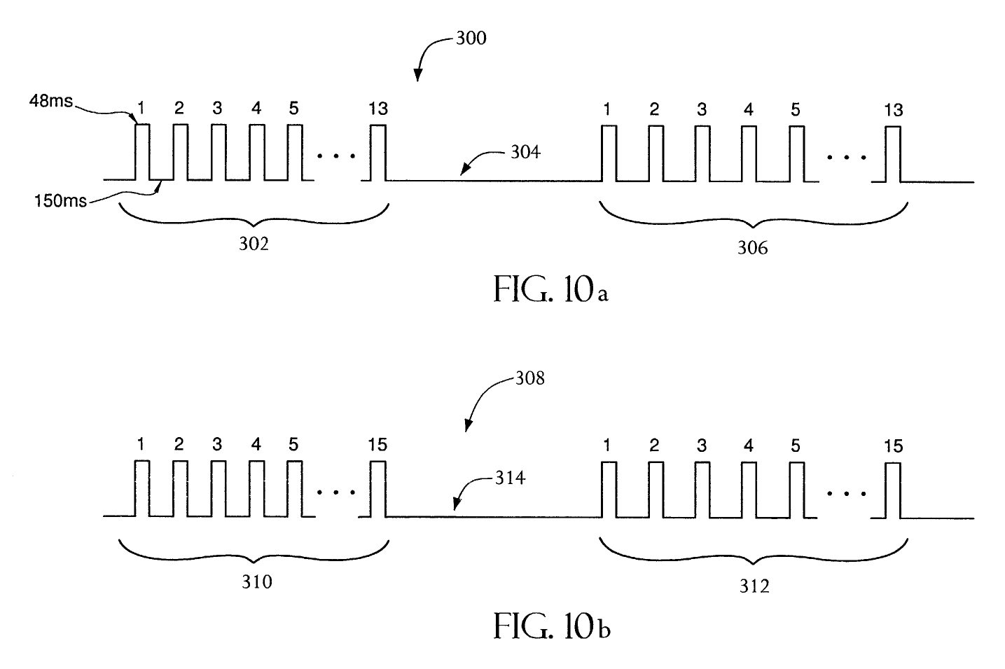

FIG. 10 illustrates the two command sequences for “Initiate Auto Align” and “Auto Align Passed” respectively. FIG. 10a illustrates the signaling sequence 300 for the “Initiate Auto Align” command. When the calibration unit detects this sequence on the tip and ring leads, the calibration unit begins the Auto Align procedure, including transmitting the 1 kHz square wave test tone to the metallic interface unit. The first portion of the signaling sequence 302 comprises 13 open-closed intervals, with each open interval preferably lasting 48 ms and each closed interval preferably lasting 150 ms. The first open-closed interval 302 is followed by an inter-sequence interval 304, which preferably lasts about one half second. Finally, a second open-closed interval 306 is transmitted, comprising another 13 sets of open and closed intervals of the same duration.

FIG. 10b illustrates the signaling sequence 308 for the “Auto Align Passed” command. When the calibration unit detects this sequence on the tip and ring leads, the calibration unit acknowledges that the Auto Align process has been completed successfully by turning on it's LED 64 for approximately 30 seconds. The sequence is similar to the “Initiate Auto Align” command, except that the first set of open-closed intervals 310 and the second set of open-closed intervals 312 each comprise 15 sets of open and closed intervals. The inter-sequence interval 314 preferably remains approximately one half second in duration.

While a preferred embodiment of the present invention has been shown and described, it is to be understood that many changes and modifications may be made thereto without departing from the spirit and scope of the invention as defined in the appended claims.

What is claimed is:

1. A communications network having a near end and a far end, said near end having a first channel unit connected thereto, and said far end having a second channel unit connected thereto,
said channel units adapted to be activated from either the first channel unit or the second channel unit to cause a signal of known amplitude and shape to be transmitted from said second channel unit over said communications network to said first channel unit,
said first channel unit adapted to receive said signal and analyze said received signal, and
said first channel unit further adapted to compensate for impairments in said communications network in both forward and reverse directions based on said analysis.

2. The communications network of claim 1, wherein said signal comprises a square wave at a fundamental frequency.

3. The communications network of claim 1, wherein said first channel unit employs discrete Fourier analysis to analyze said signal.

4. The communications network of claim 3, wherein said signal comprises a square wave at a fundamental frequency.

5. The communications network of claim 2, wherein said fundamental frequency is approximately 1 kHz.

6. The communications network of claim 4, wherein said fundamental frequency is approximately 1 kHz.

7. The communications network of claim 4, wherein said first channel unit employs discrete Fourier analysis to determine the level of the signal at said fundamental frequency and a plurality of odd harmonics thereof.

8. The communications network of claim 6, wherein said first channel unit employs discrete Fourier analysis to determine the level of the signal at said fundamental frequency and a plurality of odd harmonics thereof.

9. The communications network of claim 1, wherein said second channel unit is adapted to disconnect customer equipment from said communications network prior to and during transmission of said signal.

10. The communications network of claim 9, wherein said second channel unit is provided with an energy storage device, said energy storage device being adapted to store energy to operate said second channel unit while said first channel unit sends encoded instructions to said second channel unit in the form of interruptions in said second channel units power supply.

11. A system for compensating for line impairments in a telecommunications network comprising a communications network having a near end and a far end, said near end having a first channel unit attached thereto, and said far end having a second channel unit attached thereto,
said channel units adapted to be activated from either the first channel unit or the second channel unit to cause a signal of known amplitude and shape to be transmitted from said second channel unit over said communications network to said first channel unit,
said first channel unit adapted to receive said signal and analyze said received signal, and
said first channel unit further adapted to compensate for impairments in said communications network in both forward and reverse directions based on said analysis.

12. The system of claim 11, wherein said signal comprises a square wave at a fundamental frequency.

13. The system of claim 11, wherein said first channel unit employs discrete Fourier analysis to analyze said signal.

14. The system of claim 13, wherein said signal comprises a square wave at a fundamental frequency.

15. The system of claim 12, wherein said fundamental frequency is approximately 1 kHz.

16. The system of claim 14, wherein said fundamental frequency is approximately 1 kHz.

17. The system of claim 14, wherein said first channel unit employs discrete Fourier analysis to determine the level of the signal at said fundamental frequency and a plurality of odd harmonics thereof.

18. The system of claim 16, wherein said first channel unit employs discrete Fourier analysis to determine the level of the signal at said fundamental frequency and a plurality of odd harmonics thereof.

19. The system of claim 11, wherein said second channel unit is adapted to disconnect customer equipment from said communications network prior to and during transmission of said signal.

20. The system of claim 19, wherein said second channel unit is provided with an energy storage device, said energy storage device being adapted to store energy to operate said second channel unit while said first channel unit sends encoded instructions to said second channel unit in the form of interruptions in said second channel units power supply.

21. A method of compensating for frequency varying attenuation in a telecommunications network, said method comprising:
connecting a first channel unit to a company end of said network,
connecting a second channel unit to a customer end of said network,
transmitting a signal of known amplitude and shape from said second channel unit to said first channel unit over said network,
receiving and analyzing said signal at said first channel unit, and
amplifying signals transmitted over said network in both forward and reverse directions based on said analysis.

22. The method of claim 21, wherein said transmitting step comprises transmitting a square wave at a fundamental frequency.

23. The method of claim 21, wherein said analyzing step further comprises employing discrete Fourier analysis to analyze said signal.

24. The method of claim 23, wherein said transmitting step comprises transmitting a square wave at a fundamental frequency.

25. The method of claim 22, wherein said fundamental frequency is approximately 1 kHz.

26. The method of claim 24, wherein said fundamental frequency is approximately 1 kHz.

27. The method of claim 24, wherein said analyzing step further comprises employing discrete Fourier analysis to determine the level of the signal at said fundamental frequency and a plurality of odd harmonics thereof.

28. The method of claim 26, wherein said analyzing step further comprises employing discrete Fourier analysis to determine the level of the signal at said fundamental frequency and a plurality of odd harmonics thereof.

29. The method of claim 21, further comprising the steps of disconnecting customer equipment from said communications network at said second channel unit prior to and during transmission of said signal.

30. The method of claim 29, further comprising the steps of storing energy received from said telecommunications network in an energy storage device within said second channel unit to allow said second channel unit to operate while said first channel unit sends encoded instructions to said second channel unit in the form of interruptions in said second channel units power supply.

31. A method of commanding a device connected to a telephone network to perform an action, said method comprising:
applying a signal comprising a series of voltages to one of the set of leads consisting of the tip lead and the ring lead, each voltage being applied for a predetermined duration, such that the frequency of the signal is substantially below the voice band, said signal being associated with a desired action to be performed,
receiving said signal at a device connected to said telephone network, and
performing said desired action upon receipt of said signal.

32. The method of claim 31 wherein said applying step further comprises applying said series of voltages as an alternating pattern of a predetermined voltage and ground.

33. The method of claim 31 wherein said applying step comprises applying said series of voltages such that the frequency is below 200 Hz.

34. A method of commanding a device connected to a telephone network to perform an action, said method comprising:
connecting a commanding device to said telephone network,
connecting a command receiving device to said telephone network,
causing said commanding device to draw a predetermined DC current from said network for a predetermined duration,
sensing said current for said duration by said command receiving device, and
causing said command receiving device to perform an action associated with said current upon sensing said current for said duration.
